(19) United States
(12) Patent Application Publication
(10) Pub. No.: US 2012/0280139 A1
(43) Pub. Date: Nov. 8, 2012

(54) Method of Anion Production from Atoms and Molecules

(76) Inventor: John Vogel, Ukiah, CA (US)

(21) Appl. No.: 13/287,076

(22) Filed: Nov. 1, 2011

Related U.S. Application Data
(60) Provisional application No. 61/451,094, filed on Mar. 9, 2011.

(51) Int. Cl. H01J 27/20

(52) U.S. Cl. 250/423 R

(57) ABSTRACT

Ion sources are described for producing negative ion beams with low mass bias in which a neutral vapor of an electropositive element ionizes neutral atoms or molecules.

### CROSS REFERENCE TO RELATED APPLICATIONS

This patent application relates to, and claims the priority benefit from, U.S. Provisional Patent Application Ser. No. 61/451,094 filed on Mar. 9, 2011, which is incorporated herein by reference in its entirety

### STATEMENT REGARDING FEDERAL SPONSORSHIP

Not Applicable.

### REFERENCE TO LISTING, TABLE, OR APPENDIX

Not Applicable.

### FIELD OF INVENTION

Anion production, atomic mass spectrometry, isotope ratio mass spectrometry, accelerator mass spectrometry, isotope ratio chronology, isotope-labeled molecular tracing, isotope quantitation, ion implantation.

### BACKGROUND OF THE INVENTION

The invention relates to the design and methods of operation for sources of energetic atomic anions (negative ions). These anions have exemplary use for direct quantification of isotopic and elemental abundance ratios in isolated samples using mass spectrometry. The invention uses charge exchange between neutral atoms and molecules to create atomic and molecular anions. The invention particularly describes an ion source having little mass bias among isotopes in anion production from neutral sputtered atoms. The invention finds use in mass spectrometry for quantification of long-lived radioisotopes. The method even more particularly applies to the analysis of radiocarbon abundance in organic materials for determining their radiocarbon “age” or for quantifying the concentrations of ¹⁴C-labeled molecular constituents within biological systems. The invention is also useful in implanting ions or neutralized atoms of specific isotopes and elements into solid state structures. The neutralized atoms of the fast anions are also useful for inducing atomic reactions within regions of electromagnetic fields.

Accelerator mass spectrometry (AMS) is a sector-based mass spectrometry (MS) that accelerates negative atomic and molecular ions to high energies, 100 thousand electron Volts (keV) to 10 million eV (MeV), at which energy the ions pass through a collision cell of thin solid foil or low density gas. The collisions in the cell detach electrons from the ions, producing positive atomic cations of various charge states and destroying any molecules. The loss of isobar interference through molecular dissociation permits AMS to directly count low abundance isotopes, particularly radioisotopes, in an ion counter to abundances as low as 1:10¹⁶ after the acceleration and collision ionization. The art is described by A. E. Litherland in “Ultrasensitive Mass Spectrometry with Accelerators” published in Ann. Rev. Nucl. and Particle Sci. (v. 30: 437-473, 1980), is regularly updated at triennial international conferences on AMS whose proceedings are published in the journal, Nuclear Instruments and Methods Series B, and is the subject of multiple patents by Purser, U.S. Pat. Nos. 4,037,100; 4,973,841; 5,118,936; 5,120,956; 5,237,174; 5,569,915; 5,621,209; and 5,661,299; as well as by Schroeder in U.S. Pat. No. 6,815,666.

Most AMS spectrometers use a variant of the high intensity cesium (Cs) sputter source developed by Roy Middleton, described in Nuclear Instruments and Methods in 1983 (v. 214: 139) and in 1984 (v. 220: 105). He further demonstrated capability to produce negative carbon ion beams from gaseous carbon dioxide samples with only slight modification of the sample holding mechanism in Nuclear Instruments and Methods (v. B 43: 231, 1989). These anion sources for AMS were all presumed to exhibit mass bias, in which the different isotopes of an element are ionized with different efficiencies. Quantitative AMS analyses thus require comparison of measured samples with measured standard reference materials (SRM) to obtain accuracy. The accuracy of an AMS analysis depends on the comparability of each analyzed sample with the SRM sample(s). The precision of an AMS analysis, however, depends on the Poisson statistics of the number of the counted rare isotopes. The time required for obtaining high precision depends on the intensity of the ion beam generated from the sample. High intensity ion beams arise from sputter sources through the rapid erosion of the sample surface, which reduces the comparability of the analyzed samples with the SRM samples, providing high precision at the potential cost of degraded accuracy.

In these ion sources, an axially symmetric Cs⁺ primary beam is focused onto a sample of the material under study. The sample is presented as a surface co-planar with the sample holder face or recessed into the holder. Atoms are sputtered from the sample and undergo negative ionization that has heretofore been ascribed to electron capture as the atom leaves the Cs-covered sample surface. A theory of direct surface ionization in secondary ionization MS (SIMS) from J. K. Nørskov and B. L. Lundqvist, published as “Secondary Ion Emission in Sputtering” in Physical Review B (v. 19: 5661, 1979) taught that sputter yields of ions increase by a lowering of the surface work function. This surface ionization is only effective for approximately 10% of the sputtered atoms at most, with the remainder emerging as neutral atoms.

Anion SIMS analysis does incorporate a layer of alkali metal on the surface, as taught by Migeon and Wirtz in U.S. Pat. No. 7,205,534. This method reduces mass bias but specifically calls for the layering of the Cs on the surface as indicated by the importance of the Cs layer thickness and the dependence of that layer on erosion and deposition rates.

Fallon, Guilderson, and Brown writing in Nuclear Instruments and Methods (v. B 259: 106, 2007) showed that the variant of Middleton's high intensity source in their laboratory provided ionization efficiencies of 25 to 35%, a factor of 3 times the ionization efficiencies predicted from secondary negative ionization, indicating that a process other than surface ionization was responsible for the high ion intensities.

H. Gnaser discusses in Nuclear Instruments and Methods (vol. B 266, p. 37) the isotopic fractionation of negative carbon ions emitted under Cs sputtering in a SIMS instrument where the sample material is presented on a flat surface with a primary Cs⁺ beam of only 10-30 nA at 14.5 keV (435 μW incident power) incident at a 26° angle on the well-evacuated sample surface and finds significant mass bias. These circumstances are far from the normally-incident Cs⁺ beams delivering 8-20 W incident power to AMS samples with Cs densities near the sample that are 2 million times greater.

In a study of their high intensity Cs ion source published in Nuclear Instruments and Methods in 1994 (vol. B93, p. 39), Middleton and Klein quantified mass bias but noted inconsistencies between the theories of secondary negative ionization and the observations. The sputtering mechanism itself cannot have a mass bias because multiple monolayers are displaced from the sample every second, promoting rapid equilibration between the bulk material and the sputtered atoms. Ion intensity increased as a pit or depression developed in the sample as a result of the eroding sputter mechanism. This “pitting” increased efficiency, with less mass bias at greater efficiency. Their 1999 paper from Physical Review A (v. 60: 3786) hypothesized that ionization was not at the sample surface but within the volume of a “plasma” that glows faintly in “blue light” within sample pits. Conditions within the glowing volume were presumed by the authors to be similar to those in an alkali-vapor charge-exchange ion sources, but such collision electron exchange requires kinetic energies 1000 times higher than those available to sputtered atoms near the sample surface. The mechanism that created and sustained the apparent ionization within a glowing volume produced ions efficiently with low mass bias as the sample surface sputtered and pitted but was not understood and, hence, not reproducible.

High intensity anion beams are produced without mass bias in charge-exchange ion sources in which ionization arises in atomic or molecular collisions within a defined volume. Collisional charge-exchange is commonly understood to occur between charged ions and neutral atoms, as again taught by Purser, Litherland, and Turner in U.S. Pat. No. 7,365,350, but neutral atoms also exchange electrons in collisions when collision center-of-mass (c.m.) energies are sufficient to make up the energy deficit (ED) between one atom's ionization potential (IP) and the other's electron affinity (EA):

ED=IP−EA (1)

Collisions of neutral alkali atoms and neutral halogen molecules at less than 25 eV were used to find the EA of ground state molecules by determining the threshold energy of the appearance of positive metal ions, as reported in “Total cross sections for charge transfer between alkali atoms and halogen molecules” by Baede, Moutinho, DeVreis and Los in Chem. Phys. Lett. (vol. 3: 530, 1969). Vora, Turner, and Compton reported “Single electron excitation and transfer in collisions of alkali metal and oxygen atoms” in Physical Review A (v. 9: 2932, 1974) and showed that neutral alkali metals (e.g. Cs) in excited atomic states (*Cs) were calculated to have ionization potentials (*IP) lowered by the excitation energy of the atom, decreasing the ED and increasing the probabilities of collisional ionization of atoms at lower collision energies. Many methods involving atomic, ionic, electronic, and photonic collisions are known to produce atomic excitation without ionization in neutral atoms. These excited states decay spontaneously back to the ground state with various lifetimes depending on the electronic transitions available under their quantum mechanical spin and orbital parameters. Some “metastable” excited states are so hindered in transitions that their lifetimes extend to several hours, but most are in the nanosecond or microsecond range.

The glowing zone in sputter sources at low collision energies arises from an unusual photo-resonance caused by radiation trapping that is available specifically to Cs and Rb, as described in “Physical properties of a photoresonant cesium plasma” by Morgulis, et al in Zhurnal Eksperimentalnoi i Teoretiches Fiziches (vol. 26: 279, 1967) and accessibly reviewed in “Resonance radiation plasma” by Beterov, et al. in Uspekhi Fizicheskikh Nauk (vol. 155: 265-298, 1988). The same phenomenon occurs as “mirrorless lasing” described in “Continuous-wave mirrorless lasing in optically pumped Cs and Rb vapors” by Sharma, et al. in Applied Physics Letters (vol 39: 209-211, 1981). However, both these descriptions use an optically stimulated environment to excite alkali metals instead of the ionic, thermal, and electronic stimulation near a sputtered surface. In the latter environment, a substantial resonance exists between photons released from excited metal cations (460.4 nm from *Cs⁺) as they relax the excited 6²p_{3/2} state to the ground 6²s_{1/2} state and the wavelength (459.3 nm) needed to excite atoms back to the 7²p_{1/2} excited state, with “substantial resonance” in this instance referring to a photon energy that is equal to the energy of the excited atomic state within the limits of the atom's thermal kinetic energy. This state then decays back through the stimulating 6²p_{3/2} state transition to ground, continuing the photo-resonance, as evidenced by the “Persistent Line Tables” within the U.S. NIST “Handbook of Basic Spectroscopic Data” accessed through {http://www.nist.gov/pml/data/handbook/index.cfm}. The small energy deficit between the emitted and absorbed photons of 5.5 meV is provided by thermal kinetic energies of the alkali atoms at only a hundred degrees and by line broadening of the emitted photons at high atomic densities. This small thermal energy input is sufficient to create a self-sustaining zone of neutral *Cs atoms which reduce the C on *Cs ED to near perfect resonance (EA_{carbon}≈*IP_{excited cesium}) in the 7²p_{1/2,3/2} states.

If sufficient density of excited *Cs is present, much more than 10% of the sputtered atoms passing through the region are ionized to anions. The density of *Cs in front of the sputtered sample depends on the origin of the Cs, the shape of the volume restraining its loss to the vacuum in the ion source, and the delivery of energy for exciting Cs to *Cs. The origin of Cs in a Middleton sputter ion source is the hot (1100° C.) surface that ionizes a stream of neutral Cs created in a warm reservoir connected to the hot ionizing surface. These Cs⁺ primary ions are driven toward the sample by a multi-kilovolt difference between the ionizing surface and the sample, where they embed into the surface of the sample and sample holder, sputtering and heating the sample and surroundings. A 1.5 mA Cs⁺ primary ion current (10¹⁶ per second) that reaches equilibrium with Cs⁰ leaving the sample as vapor at 600° K thermal energy leaves a density of 0.6×10¹⁴ Cs⁰/cm³ in 1.5 mm deep recess of 1 mm diameter into which the sample is pressed, for an areal density of 10¹³/cm². The ion source body is evacuated to better than 10⁻⁶ mbar and the volume holding Cs⁰ in front of the sample develops a vapor pressure of about 1 mbar on the surface at 250° C., which vapor is retained in a volume with lowered gas conductance, such as a recess, a chamber, or a set of baffles. The volume in front of the sample is a high energy environment, with multi-keV primary Cs⁺, secondary sputtered electrons of having a distribution of energies around 2 eV energy, and sputtered ions and atoms of 4 eV average energies. The maximum energies of the sputtered species depend on the energy of the primary ions, which must be more than 2 keV for sputtered species to excite neutral Cs vapor. Primary ion energies are more typically 5 to 15 keV. Collisions of Cs⁰ with primary Cs⁺ and secondary electrons induces some Cs⁺ to excited states, especially the lowest states 6²p_{1/2,3/2} at 1.4 eV above ground. *Cs in these low states pool energy in collisions to the higher 7²p_{1/2,3/2} states with high probability above a 360° K threshold. In this manner, an initiating population of *Cs⁰ in 7²p_{1/2,3/2} states at 2.7 eV is created that promotes the photoresonance described above for the relaxing *Cs⁺. The cross section for producing an anion from the collision of C⁰ and *Cs⁰ is more than 100 Å² (100×10⁻¹⁶ cm²) for *Cs in the 7²p_{1/2,3/2} excited states. The areal density of 10¹³ Cs⁰/cm² in front of a 1 mm diameter sample produces anions from at least 10% of the passing atoms. Alternatively, a laser tuned to 458 nm photons substantially sustains most Cs⁰ in the 7²p_{1/2,3/2} excited states, where “substantially” in this instance means greater than 75%. This mechanism of ionization in neutral atomic collisions explains many observed phenomena of negative sputter ion sources, including the recent discovery of undetectable mass bias in a sputter ion source used for accelerator mass spectrometry, as reported in a paper submitted to Nuclear Instruments and Methods B for the proceedings of the 2011 AMS conference (Vogel, Giacomo, and Dueker, 2011, submitted). Exploiting this mechanism improves and expands the capacities of sputter ion sources and suggests designs for new forms of ion sources without mass bias.

One solution to the mass bias found in SIMS ion sources is to ionize and analyze the neutral atoms that the primary ion beam sputters from the sample. Such neutral sputtered atoms are as much as 10 times more copious than the sputtered negative ions. The neutral flux from the sample has little or no mass bias since there can be no velocity-dependent electrical interaction with the surface, and the neutral emissions integrated over time are perforce in isotopic equilibrium with the bulk sample, as in this invention. However, the atoms of sputtered neutral MS (SNMS) are ionized post-sputter by passage through an argon plasma as taught by Meier and Müller in U.S. Pat. No. 4,670,651, by electron impact from an accelerated electron beam, or by resonant laser ionization as taught by Gruen, Pellin, and Young in U.S. Pat. No. 4,633,084. Ion sources for SNMS often use Cs⁺ primary ions for sputtering the neutral sample atoms, but separate the process of ionization of the sputtered atoms some distance from the impact of the primary Cs ion beam. Heretofore, post-sputter ionization of neutral sputtered atoms by neutral Cs vapor has not been proposed.

In this invention, neutral atoms are negatively ionized by neutral metal vapor through which atoms pass prior to accelerating in electric fields within an ion source, providing mass independence in the ionization of the atomic flux.

### SUMMARY OF INVENTION

### Technical Problem

Anions produced from sputtered sample surfaces by secondary ionization show large and variable mass bias among the elemental and isotopic constituents, with further dependence on the matrix of the sample from which they are sputtered. Sputtering is indiscriminate, ejecting ions, atoms, molecules, and atomic clusters from the sample which must be removed or quantified as distinct from the specie of interest. Accurate quantification of elemental or isotopic abundance ratios in the samples from such ion sources is difficult and requires that SRM samples be prepared and ionized in scrupulously identical circumstances so that the measured responses from samples are correctly normalized to SRM. Irreducible uncertainties in quantification result from the difficulty of maintaining perfect similarity among samples of analyzed materials and SRM.

### Solution to Problem

The vast plurality of the sputtered species emerge as neutral atoms or molecules. These neutral emitted species show little mass bias in emission and are not subject to matrix-dependent emission. These emitted neutral species reflect the elemental and isotopic concentrations within the bulk sample material to a high accuracy. These emitted atoms are ionized post sputter in collisions with neutral alkali atoms.

This invention, unlike traditional SNMS, uses neutral Cs or other highly electropositive atoms that are vaporized from or near the hot sample, sample holder, and surrounding surfaces as the ionizing agent in a post-sputter ionization negative ion source (PSINIS).

The probability of transferring an electron from a neutral Cs atom in the vapor phase to neutral sample atoms during a collision is high, having a physical cross-section of 10 Å² or greater. The probability of this post-ionization is increased by exciting the ionizing Cs atoms to higher electronic states so that the ED of the collision is reduced. Atoms are raised to excited states through electron, ion, or photon bombardment, particularly through the use of selected wavelength lasers that excite atoms to specific excited states.

The sputtered atoms include elements other than that under analysis. The excited state of the *Cs vapor may be adjusted through photonic excitation by specific wavelengths to induce a resonant ionization of the desired element while suppressing unwanted elements.

Sufficient ionizing vapor is provided to ionize not only the species under analysis, but also all other sputtered species that deplete the ionizing vapor density below that required for maximum ionization of the analyzed specie.

The sputtered neutral species are ionized by neutral alkali atoms in volumes of low electric fields, providing no opportunity for velocity (and mass) dependent speciation in the ionization. The combination of mass-independent sputtering of neutral atoms from a sample with a mass-independent ionization of the neutral species by collision with excited neutral atoms provides anions from a bulk sample with little mass bias.

### Advantageous Effects of Invention

Multiple applications of this ion source for elemental and isotopic analysis of material samples will be clear to anyone skilled in the art, but include: determination of relative isotopic and elemental abundances within isolated samples, chronometric analysis of samples containing natural radioactive isotopes, metrological quantification of element concentrations using isotope dilution methods, quantification of isotope-labeled molecular species within bioanalytic materials, and ion implantation of specific elemental or isotopic species.

It is an object of the present invention to provide an ion source for isotope ratio MS (IRMS) that produces an anion beam that reflects a sample's isotope and element abundance without mass bias within the portion of a sample being analyzed.

It is a further object of the present invention to provide an ion source for use with an absolute IRMS (AIRMS) that directly quantifies absolute abundances of both stable and radio-isotopes within a sample without normalization of the measurement to a separate sample of SRM.

It is another object of this invention to provide an ion source for IRMS and AIRMS analysis from which isotope dilution analyses can be performed over wide dynamic ranges in the isotope concentrations of diluent and sample without need of normalizing and calibrating SRMs.

It is yet another object of the present invention to increase the ion intensity obtained from isolated samples so that the rare isotopes within those samples may be quantified to greater precisions in shorter time periods.

It is also an object of the invention to allow selective ionization of neutral sputtered atoms by adjusting the excited state of the sample atom, the ionizing atom, or both using specific wavelengths of light to enhance ionization of the desired element while suppressing ionization of other sputtered components.

It is a still further object of the present invention to provide an ion source that produces an anion beam without mass bias from samples that may have inhomogeneous distributions of isotopes and elements, allowing continuous quantification of those inhomogeneities.

It is an advantage of the present invention that ion beams derived continuously from gas streams produced from eluents of chemical reparatory instruments are produced without mass bias, so that internal or external SRM are not required for accurate quantification of temporal constituents of the eluates.

It is yet one more object of this invention to provide a new method of ionizing neutral species sputtered from surfaces under study by sputtered neutral mass spectrometry (SNMS).

Features and advantages of the present invention will become apparent from the following description, which includes drawings of specific embodiments, to give a broad representation of the invention. Various changes and modifications within the spirit and scope of the invention will become apparent to those skilled in the art from this description and by practice of the invention. The scope of the invention is not limited to the particular forms disclosed and the invention covers modifications, equivalents, and alternatives falling within the spirit and scope of the invention.

### BRIEF DESCRIPTION OF THE DRAWINGS

FIG. 1 A medial plane of the axially symmetric active components of a cesium sputter ion source are shown.

FIG. 2 A medial plane of the axially symmetric active components of a cesium sputter ion source are shown with a different geometry of a sample holder (206) and ionizing volume (219).

FIG. 3 A medial plane of a sample holder (306) and carrier (307) are shown with the ionizing volume (319) incorporated within the carrier (307).

FIG. 4 A medial plane of the axially symmetric active components of a cesium sputter ion source for the use of gas sample material is shown.

### DESCRIPTION OF EMBODIMENTS

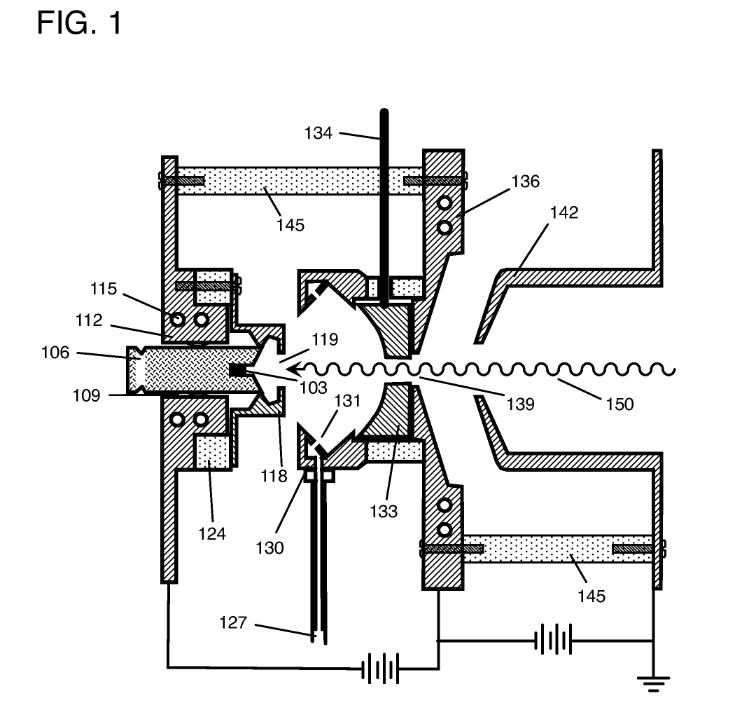

Referring to FIGS. 1 through 5, wherein like numbers refer to similar parts, the invention is described. The Figures show only schematic representations of a sputter ion source and are illustrative only. Those skilled in the art will recognize the relation between the described components in the Figures and the specific components in particular realizations of a sputter ion source. Components required for an understanding of the invention and its application are represented in the Figures, and those skilled in the art recognize how these components are typically arranged within evacuated volumes and supplied with electrical currents and potentials from power supplies, cooling water from circulation pumps, metal vapor from a boiler, and gases from a pressurized cylinder or other storage. Cs is the most common metal vapor used in these sputter ion sources and is referred to here as only representative of the potential sputtering primary ions that may include the alkali and alkali-earth metals or the noble gases. The Figures are medial views through an otherwise axially symmetric construction with singular instances of power lines (134) and vapor pipe (127) extending beyond the orthogonally represented components. This type of ion source is typically connected to a mechanical system (not shown) that is capable of sequentially placing one of a plurality of sample holders (106) into the active position of the ion source demarcated by the illustrated positions of the sample holder (106, 206, and 406 in FIGS. 1, 2, 4, and 5).

The typical operation of this ion source is described with reference to FIG. 1, in which a solid sample to be analyzed (103) is pressed into an electrically conducting sample holder (106) prior to being placed into the active position of the source, where it is shown. The sample holder in this embodiment is retained in position with springs or ball detents (109) that provide moderate thermal conduction to the mounting plate 112 that is cooled by circulating water in channels 115. Cesium (Cs) metal vapor is created in a boiler (not shown) and brought to the ion source through tube 127 where it disperses around a distribution ring (130) and emerges from a series of holes (131) facing a high temperature hemispherical surface of an ionizer (133) that is powered through wire 134. The ionizer is at 1100° C. or hotter, causing the Cs atoms to thermally lose an electron, becoming positive ions. These positive ions are repelled from the ionizer by the electric field created by holding plate 112 at a “cathode potential” that is more electrically negative than plate 136. The Cs ions are accelerated toward the sample (103) in this electric field that is shaped by the hemispherical surface of the ionizer (133) and the round opening of a lens (118). Cs ions strike the sample surface, sputtering sample atoms, with the large plurality of the sputtered ions being uncharged neutral atoms. The electrical current of positive Cs ions (typically 1.5 mA) represents 10¹⁶ Cs atoms per second striking the sample and sample holder. These ions become neutral atoms on the surfaces of the sample holder (106) where the surface temperature is sufficient to maintain a vapor pressure of neutral Cs in the volume (119) in front of the sample (103). Neutral sample atoms sputtered from the sample (103) are negatively ionized by collisions with neutral Cs atoms, and even more readily ionized by collisions with Cs atoms in excited states. Negative sample ions drift at their sputtered velocity into the electric field between the lensing shroud (118) and the ionizer (133) where they are accelerated. The opening of the shroud (118) and the shape of the ionizer (133) focus these negative ions through the opening (139) where they may be further accelerated by the potential difference between plate 136 and the extraction electrode (142). The accelerating components are held in position by insulating spacers (145). A source of photons may be axially introduced to excite Cs or sample atoms (150).

The simplest embodiment of the invention uses the recess volume between the surface of the sample (103) and the end of the sample holder 106 to trap a portion of the neutral Cs vapor as the ionizing volume for neutral atoms sputtered from the sample surface. In that case, the sample 103 is recessed at least one or more hole diameters from the surface of the sample holder and the shroud (118) is a skeletal support of its lensing aperture for improving vacuum near the sample.

In another embodiment, the front of the sample holder extends to the shroud (118) that is thermally insulated by a ring (124) from the mounting plate (112) and is heated by the radiant energy of the ionizer (133). This heated surface has sufficient temperature to create a significant vapor pressure of Cs in the vicinity of the shroud. The heat further acts to drive off any sample atoms that can form a contaminant background signal for subsequent samples. The shroud defines a volume (119) that can be shaped for optimal retention of neutral Cs vapor boiled off the sample holder and shroud for the purpose of negatively ionizing any neutral sample atoms that pass out of the sample.

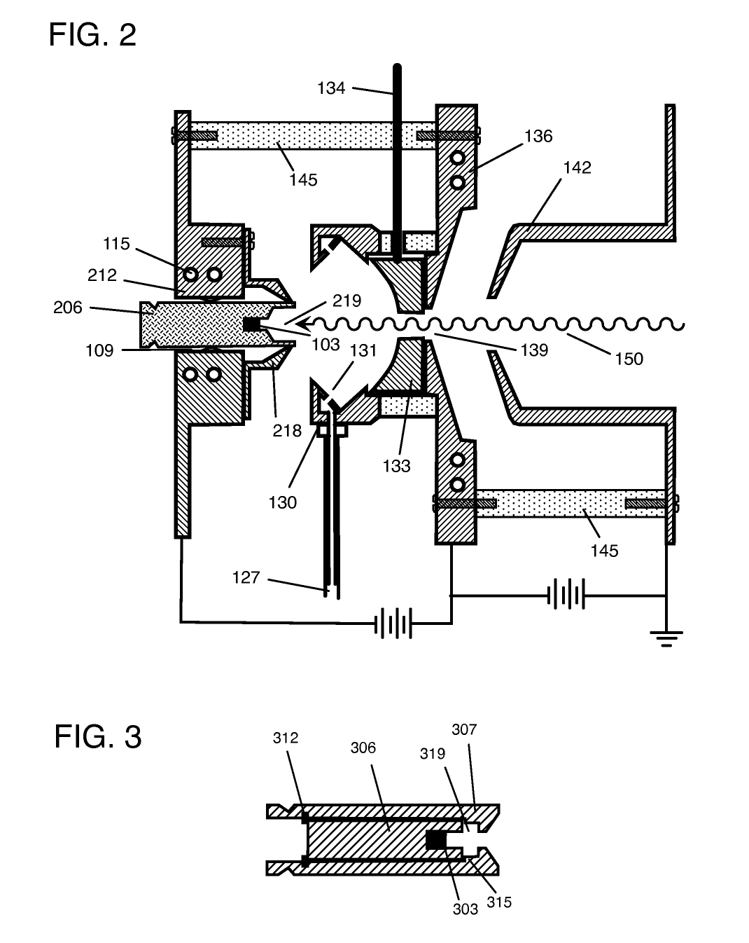

Alternatively, another embodiment of the invention is shown in FIG. 2, in which the sides of the sample holder (206) are extended in order to incorporate the ionizing volume (219) within constraining walls that are removed and replaced by the entry of a new sample holder. A differently shaped lensing shroud (218) mounted on plate 212 and the circular walls of the sample holder (206) focus both the incident positive Cs ions and the emitted negative sample ions in a manner similar to the embodiment shown in FIG. 1.

An embodiment of the invention that also serves to replace the volume of Cs vapor during every change of sample holder is shown in FIG. 3. In this embodiment, the sample holder (306) is a simple cylinder of metal that has a blind hole into which the sample material (303) is pressed. This sample holder is then secured by a spring clip (312) within a cylindrical carrier (307) that fits within the sample position of the ion source and is capable of being loaded by the sample changing mechanism (not shown). The face of the sample holder (306) is held back from the front of the sample carrier (307) by a small ridge (315) to create the volume (319) in which vaporized Cs concentrates for the ionization of neutral atoms sputtered from the sample (303).

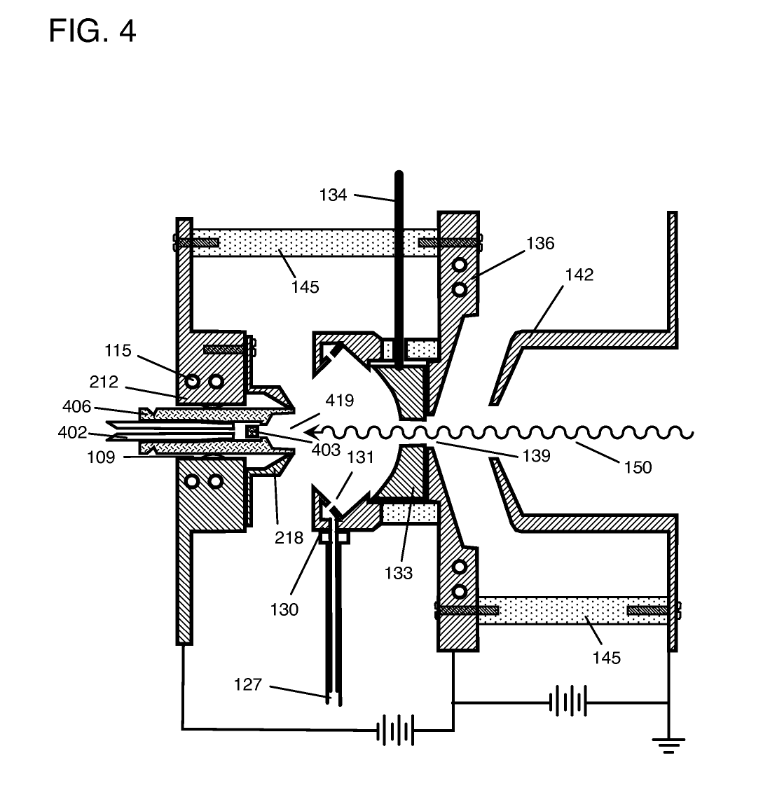

A high intensity Cs sputter source is adapted for accepting gaseous samples rather than solid samples by introducing the gas through a quartz capillary tube (402) as shown in FIG. 4. The gas flows around a metal anvil (403) incorporated into the sample holder (406). The Cs breaks up molecular gas at or above the surface of the anvil (403). As with the solid sample, some atoms are ionized at the surface and emerge as negative ions. A larger fraction emerge as neutral atoms that are ionized by neutral Cs vapor in front of the anvil in the sample holder and in the volume 419. The modification of the sample holder (206) from the embodiment of FIG. 2 is also incorporated in this embodiment for gas analysis for illustration. A variation on the sample holder of FIG. 3 including a capillary gas inlet provides a larger volume of the gas sample to ionize with the trapped Cs.

Another embodiment of this invention allows neutral cesium vapor to emerge from the cesium distribution ring (130) not only through the holes pointing toward the heater (131), but also toward the sample (103) and the volume (119) in front of the sample holder (106) such as the shroud (118) of FIG. 1 or the volumes (219 and 419) defined by the sample holder (206 and 406) respectively in FIGS. 2 and 4.

Yet another embodiment incorporates a separate source of Cs or other ionizing vapor to fill a volume in line with the path of neutral atoms from a sample, whether or not that volume is defined by constraining structures.

All embodiments of the invention include instances of transforming the ionizing vapor to one or more of its excited states in order to increase the probability of negative ionization and to lower the collision velocity required for ionization. This excitation is accomplished with energetic electrons, energetic positive ions such as the primary Cs⁺ ion beam, or photons from lasers (150) capable of selecting specific excited states within the neutral ionizing vapor.

Particular embodiments of the invention are described here to suggest multiple methods for creating a volume of neutral ionizing vapor directly in front of a sample for the purpose of negatively ionizing neutral atoms sputtered from the sample material. These embodiments are described with reference to particular drawings of a high intensity cesium sputter ion source. The particular drawings and embodiments are merely illustrative and are not restrictive on the spirit of the invention. Those skilled in the art recognize that specific geometries and materials for the various components may vary. The invention specifically incorporates methods of increasing the density of neutral vapor of Cs in excited states in a region of low electric fields through which neutral atoms sputtered from a sample pass.

### CITATION LIST

U.S. Pat. Nos.

| | | |
|---|---|---|
| 4,037,100 | July 1977 | Purser |
| 4,670,651 | June 1987 | Meier |
| 4,633,084 | December 1986 | Gruen, et al. |
| 4,973,841 | November 1990 | Purser |
| 5,118,936 | June 1992 | Purser |
| 5,120,956 | June 1992 | Purser |
| 5,237,174 | April 1993 | Purser |
| 5,569,915 | October 1996 | Purser |
| 5,621,209 | April 1997 | Purser |
| 5,661,299 | August 1997 | Purser |
| 6,815,666 | November 2004 | Schroeder, et al. |
| 7,205,534 | April 2007 | Migeon, et al. |
| 7,365,340 | April 2008 | Purser, et al. |

U.S. Pat. Appl.

| | | |
|---|---|---|
| 13/031,530 | February 2011 | Vogel |

### OTHER

Nuclear Instruments and Methods in Physics Research B North Holland Publishing, Amsterdam “Total cross sections for charge transfer between alkali atoms and halogen molecules” A. P. M. Baede, A. M. C. Moutinho, A. E. DeVreis and J. Los (1969) Chem. Phys. Lett. 3: 530. “Ultrasensitive Mass Spectrometry with Accelerators” A. E. Litherland, (1980) Ann. Rev. Nucl. and Particle Sci. (v. 30: 437-473, 1980)
“A Versatile High Intensity Negative Ion Source” R. Middleton. (1983) Nuclear Instruments and Methods in Physics Research 214: 139-150. North Holland, Amsterdam.
“A Versatile High Intensity Negative Ion Source” R. Middleton. (1984) Nuclear Instruments and Methods in Physics Research 220: 105-106. North Holland, Amsterdam.
“A CO₂ Negative Ion Source for ¹⁴C Dating” Middleton, et al. (1989) Nuclear Instruments and Methods in Physics Research B43: 231-239. North Holland, Amsterdam.
“Isotopic Fractionation of Negative Ions Produced by Cs Sputtering in a High-intensity Source” R. Middleton, D. Juenemann, J. Klein. (1994) Nuclear Instruments and Methods in Physics Research B93: 39-51. North Holland, Amsterdam.
“Production of metastable ions in a cesium sputter source: Verification of the existence of N₂⁻ and CO⁻.” R. Middleton and J. Klein. (1999) Physical Review A 60: 3786-3799.
“Secondary Ion Emission in Sputtering” J. K. Norskov and B. L. Lundqvist (1979) Physical Review B 19: 5661.
“CAMS/LLNL Ion Source Efficiency Revisited” S. J. Fallon, T. P. Guilderson, T. A. Brown. (2007) Nuclear Instruments and Methods in Physics Research B259: 106-110. North Holland, Amsterdam.
“Physical properties of a photoresonant cesium plasma” N. D. Morgulis, et al (1967) Zhurnal Eksperimentalnoi i Teoretiches Fiziches 26: 279.
“Resonance radiation plasma” I. M. Beterov, et al. (1988) Uspekhi Fizicheskikh Nauk 155: 265-298.
“Continuous-wave mirrorless lasing in optically pumped Cs and Rb vapors” A. Sharma, et al. (1981) Applied Physics Letters 39: 209-211.
“Single electron excitation and transfer in collisions of alkali metal and oxygen atoms” Vora R B, Turner J E, Compton R N (1974) Phys Rev A 9:2532.
“Cesium post-ionization in the high intensity negative sputter ion source” J. S. Vogel, J. A. Giacomo, and S. R. Dueker (submitted) Nuclear Instruments and Methods B.

What is claimed is:

1. A source of atomic or molecular ions in which a vapor of neutral electropositive atoms negatively ionizes neutral atoms or molecules through electron transfer during collision.

2. A source of negative ions as described in claim 1 in which the neutral electropositive atoms are in one or more excited atomic states.

3. A source of negative ions as described in claim 1 in which the neutral electropositive atoms are promoted to specific excited atomic states by irradiation with photons having energies substantially resonant with the specified excited states.

3. A source of negative ions as described in claim 1 in which the neutral atoms to be ionized are in one or more excited atomic states.

4. A source of negative ions as described in claim 1 in which the neutral atoms to be ionized are promoted to specific excited atomic states by irradiation with photons having energies substantially resonant with the specified excited states.

5. A source of negative ions as described in claim 1 in which the ionizing collisions occur in a region of low electric fields, with the ions drifting from the ionization region under the remaining momentum with which they entered that region.

6. A source of negative ions as described in claim 1 in which the ionizing collisions occur in a region of controlled electric fields, with the ions removed from the region under the influence of constant or pulsed electric fields.

7. A source of negative ions in which neutral sputtered atoms or molecules are ionized by a vapor of neutral Cs or Rb that is of a density and temperature to promote a photoresonance production of excited states between decaying excited cations and neutral atoms of Cs or Rb.

8. A source of negative ions incorporating: a primary ion beam of Cs⁺ of at least 1 mA current accelerated across at least 2 kiloVolt potential, that is axially aligned with and focused on a sample material held within an electrically conducting sample holder, from which sample material neutral atoms are sputtered with low mass bias into a volume containing neutral Cs vapor resulting in the ionizing of the sputtered neutral atoms, and which volume is positioned prior to the acceleration of the ionized atoms in an electric field prior to molecular, elemental, or isotopic analysis of the sample by mass spectrometry.

9. An ion source as described in claim 8 in which the incident primary Cs⁺ ion beam is neutralized on collision with the sample and/or sample holder and is evaporated as a neutral atomic vapor.

10. An ion source as described in claim 8 in which the sample surface is depressed below the front surface of the electrically conductive sample holder to form a confining Cs vapor volume.

11. An ion source as described in claim 8 in which the retention volume for Cs vapor is defined by walls extending forward from the sample holder.

12. An ion source as described in claim 8 in which the Cs retention volume resides within a sheathing carrier that contains the sample holder, the sample being aligned with an exit from the sheath beyond the vapor retention volume.

13. An ion source as described in claim 8 in which Cs vapor is created near or brought to the front of a sputtered sample without being specifically confined by physical structures.

14. An ion source as described in claim 8 in which a gaseous sample is introduced into the retention volume of Cs vapor.
